(19) United States
(12) Patent Application Publication
(10) Pub. No.: US 2014/0116189 A1
(43) Pub. Date: May 1, 2014

(54) CONTROL CABLE TERMINAL SUPPORTING APPARATUS

(71) Applicants: Kazuyoshi Nono, Nagoya (JP); Masahiko Aoki, Nagoya (JP); Yoshikatsu Tsuge, Nagoya (JP); Kazumichi Miyashita, Nagoya (JP)

(72) Inventors: Kazuyoshi Nono, Nagoya (JP); Masahiko Aoki, Nagoya (JP); Yoshikatsu Tsuge, Nagoya (JP); Kazumichi Miyashita, Nagoya (JP)

(73) Assignee: CHUO HATSUJO KABUSHIKI KAISHA, Nagoya (JP)

(21) Appl. No.: 14/124,189

(22) PCT Filed: Jun. 5, 2012
(86) PCT No.: PCT/JP2012/064473

§ 371 Date: Dec. 5, 2013

(30) Foreign Application Priority Data
Jun. 8, 2011 (JP) 2011-128699
Jun. 8, 2011 (JP) 2011-128701
Nov. 15, 2011 (JP) 2011-250104
Jun. 5, 2012 (JP) PCT/JP2012/064473

(51) Int. Cl. F16C 1/10

(52) U.S. Cl. CPC F16C 1/102
USPC 74/502.4

(57) ABSTRACT

A terminal supporting apparatus 10 supports at least one of two ends of a control cable having an inner cable and an outer cable. The terminal supporting apparatus 10 includes: a hub 12 attached to an end of the outer cable, and having a flange on an outer periphery thereof; a cushion member 14 disposed to surround the outer periphery of the hub, and being in contact with the flange at both a front surface and a rear surface of the flange; and a housing 17 having a housing part that houses the cushion member. When an angle formed between an axis of the housing part and an axis of the hub is varied in a range of 0.0° to 6.0°, a diagonal static spring constant of the cushion member in an axial direction thereof may be in a range of 350 to 600 N/mm.

### TECHNICAL FIELD

The technique disclosed in the present specification relates to an apparatus (hereinafter referred to as a terminal supporting apparatus) for supporting an end of a control cable (e.g., a control cable disposed between a shift lever and a transmission of an automobile).

### BACKGROUND ART

Generally, a control cable has a tubular outer cable and an inner cable inserted in the outer cable. One end of the outer cable is attached to a housing or the like of an input device, and the other end of the outer cable is attached to a housing or the like of an output device. The inner cable is guided from the input device to the output device by the outer cable. An operation (e.g., a pushing/pulling operation) performed on the input device by an operator is input to one end of the inner cable. The operation input to the one end of the inner cable is transferred through the other end of the inner cable to the output device.

When the input device and the output device are connected by the control cable as described above, vibration of the output device may be transmitted to the input device via the control cable, or vibration of the input device may be transmitted to the output device via the control cable. Therefore, a technique for preventing the transmission of vibration between the input and output devices via the control cable has been developed (e.g., Japanese Patent Application Publication No. 2008-019977). In the technique disclosed in Japanese Patent Application Publication No. 2008-019977, an end of an outer cable is attached to a housing via a cushion member. A plurality of protrusions is formed on a surface of the cushion member that is in contact with the housing. The plurality of protrusions, formed on the contact surface with the housing, restrains the transmission of vibration.

### SUMMARY OF THE INVENTION

### Technical Problem

Although a certain level of vibration control effect is achieved by using the technique disclosed in Japanese Patent Application Publication No. 2008-019977, it is desired to realize a technique capable of providing higher vibration control effect. In the present specification, therefore, it is an object to provide a terminal supporting apparatus capable of further restraining transmission of vibration.

### Solution to Technical Problem

A first terminal supporting apparatus disclosed in the present specification supports at least one of two ends of a control cable having an inner cable and an outer cable in which the inner cable is inserted. The terminal supporting apparatus includes: a hub that is attached to an end of the outer cable, and has a flange on an outer periphery thereof; a cushion member that is disposed so as to surround the outer periphery of the hub, and is in contact with the flange at both a front surface and a rear surface of the flange; and a housing having a housing part that houses the cushion member. When an angle (so-called twisting angle) formed between an axis of the housing part and an axis of the hub is varied in a range of 0.0° to 6.0°, a diagonal static spring constant of the cushion member in an axial direction thereof is in a range of 350 to 600 N/mm.

In the first terminal supporting apparatus, when the twisting angle is varied in the range of 0.0° to 6.0°, the diagonal static spring constant of the cushion member in the axial direction thereof is in the range of 350 to 600 N/mm. As described later, according to an experiment performed by the inventors of the present invention, it is found that transmission of vibration can be restrained as compared to the conventional technique if the above condition is satisfied. According to the first terminal supporting apparatus, vibration transmitted via the control cable can be successfully restrained by setting the diagonal spring constant to an appropriate value.

In the first terminal supporting apparatus, the condition of the diagonal static spring constant may be satisfied by controlling a clearance between the cushion member and a supporting member. For example, according to an aspect of the first terminal supporting apparatus, dimensions of the cushion member and the housing part may be set such that no clearance is formed between the cushion member and an inner wall surface of the housing part in a direction along which the axis of the housing part extends, while a clearance is formed in a direction perpendicular to the axis of the housing part. Whether a clearance is formed between the cushion member and the inner wall surface of the housing part depends on the load applied to the cushion member, or the housing state of the cushion member in the housing part (e.g., a twisting angle or the like). Therefore, it doesn't matter whether the clearance is actually formed when the cushion member is housed in the housing part, so long as the dimensions are set to values that allow the formation of the clearance.

A second terminal supporting apparatus disclosed in the present specification supports at least one of two ends of a control cable having an inner cable and an outer cable in which the inner cable is inserted. The terminal supporting apparatus includes: a hub that is attached to an end of the outer cable, and has a flange on an outer periphery thereof; a cushion member that is disposed so as to surround the outer periphery of the hub, and is in contact with the flange at both a front surface and a rear surface of the flange; and a housing having a housing part that houses the cushion member. When a clearance in a direction perpendicular to the axes of the cushion member and the housing part is C, 0.1 mm≦C≦0.8 mm is satisfied. More preferable range of the clearance C is 0.25 mm≦C≦0.8 mm.

In the second terminal supporting apparatus, transmission of vibration via the control cable can be successfully restrained by setting the clearance C between the cushion member and the housing part (specifically, the clearance in the direction perpendicular to the axes thereof) to an appropriate value.

Further, in the second terminal supporting apparatus, when a length of the cushion member in the axial direction thereof is Xc, 9.5 mm≦Xc≦13.5 mm is preferably satisfied.

In the first and second terminal supporting apparatuses, the hub and the cushion member may be integrally molded so that no clearance is formed between the hub and the cushion member. By integrally molding the hub and the cushion member, assembly of the terminal supporting apparatus is facilitated.

### BRIEF DESCRIPTION OF DRAWINGS

FIG. 1 is a diagram schematically showing an entire configuration of an AT cable using a terminal supporting apparatus according to Embodiment 1.

FIG. 2 is a cross-sectional view of the terminal supporting apparatus, taken along a plane that passes through a cable axis.

FIG. 3 is a cross-sectional view showing a cushion and a hub.

FIG. 4 is a cross-sectional view of a bracket, taken along a plane that passes through the cable axis.

FIG. 5 is a cross-sectional view showing a cushion and a hub according to a modification of Embodiment 1.

FIG. 6 is a diagram describing a procedure of measuring a diagonal static spring constant.

FIG. 7 is a diagram showing measurement results of diagonal static spring constants.

FIG. 8 is a cross-sectional view of a terminal supporting apparatus of Embodiment 2, taken along a plane that passes through the cable axis.

FIG. 9 is a cross-sectional view for describing a modification (hereinafter referred to as Modification 1) of the terminal supporting apparatus of Embodiment 2.

FIG. 10 is a cross-sectional view for describing another modification (hereinafter referred to as Modification 2) of the terminal supporting apparatus of Embodiment 2.

FIG. 11 is a cross-sectional view for describing another modification (hereinafter referred to as Modification 3) of the terminal supporting apparatus of Embodiment 2.

FIG. 12 is a cross-sectional view for describing another modification (hereinafter referred to as Modification 4) of the terminal supporting apparatus of Embodiment 2.

FIG. 13 is an enlarged cross-sectional view of a part of the terminal supporting apparatus of Modification 4.

FIG. 14 is a diagram for describing a variation of the terminal supporting apparatus of Modification 4.

FIG. 15 is a cross-sectional view for describing another modification (hereinafter referred to as Modification 5) of the terminal supporting apparatus of Embodiment 2.

FIG. 16 is an enlarged cross-sectional view of a part of the terminal supporting apparatus of Modification 5.

### DESCRIPTION OF EMBODIMENTS

### Embodiment 1

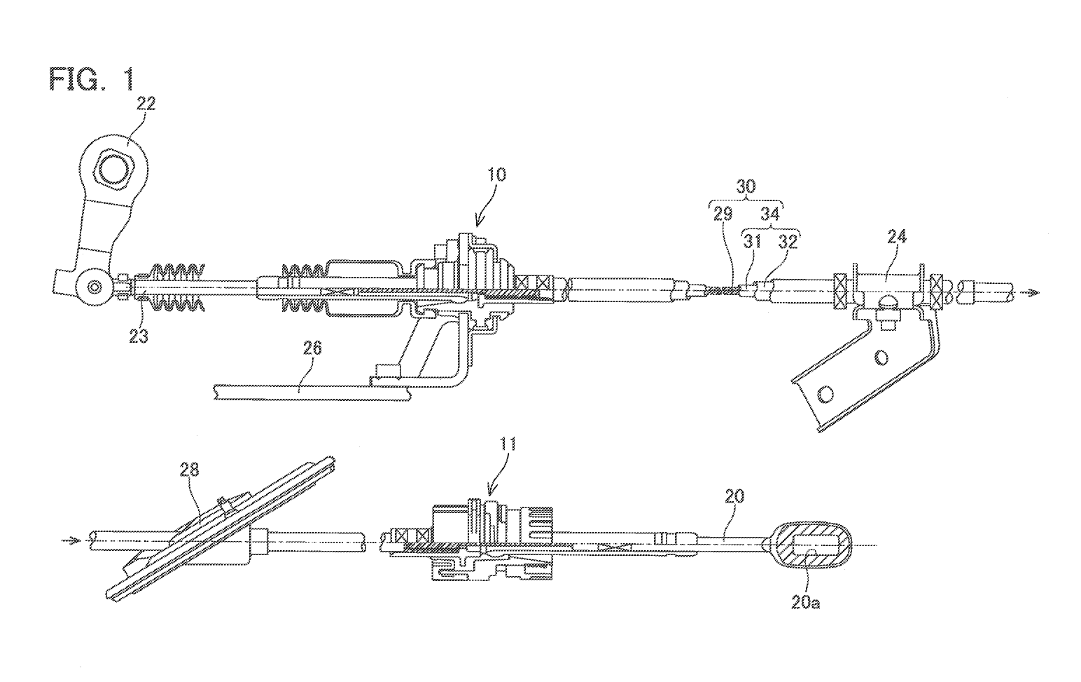

A terminal supporting apparatus according to Embodiment 1 will be described. The terminal supporting apparatus according to Embodiment 1 supports an end of an automatic transmission cable (hereinafter referred to as an AT cable) arranged between a shift lever and an automatic transmission (hereinafter referred to as a transmission) of an automobile. As shown in FIG. 1, an AT cable 30 includes an inner cable 29 and an outer cable 34. The outer cable 34 has a resin liner 31, and a covering part 32 that covers an outer periphery of the resin liner 31. The covering part 32 is composed of a stranded wire and a resin coating. The inner cable 29 is inserted in the outer cable 34, and is movable forward and backward in the outer cable 34. An input rod 20 is connected to one end of the inner cable 29, and an output rod 23 is connected to the other end thereof.

A hole 20a is formed at a tip end of the input rod 20. A shift lever (not shown) is connected to the hole 20a. A tip end of the output rod 23 is connected to a transmission (not shown) provided in an engine room, via a link member 22. An operation (displacement) input to the shift lever by a driver is transferred to the inner cable 29 via the input rod 20. The displacement transferred to the inner cable 29 is transferred to the transmission via the output rod 23 and the link member 22.

An end of the outer cable 34 on the input rod 20 side is supported by a terminal supporting apparatus 11. The terminal supporting apparatus 11 is fixed to a housing of a shift lever device. An end of the outer cable 34 on the output rod 23 side is supported by a terminal supporting apparatus 10. The terminal supporting apparatus 10 is fixed to a cable fixing member 26 in the engine room. An intermediate part of the outer cable 34 is clamped to a predetermined portion of a vehicle body by means of a fastener 24 and a retainer 28. In Embodiment 1, the input-side terminal supporting apparatus 11 has the same configuration as the conventionally known terminal supporting apparatus, and therefore, the output-side terminal supporting apparatus 10 will be described hereinafter.

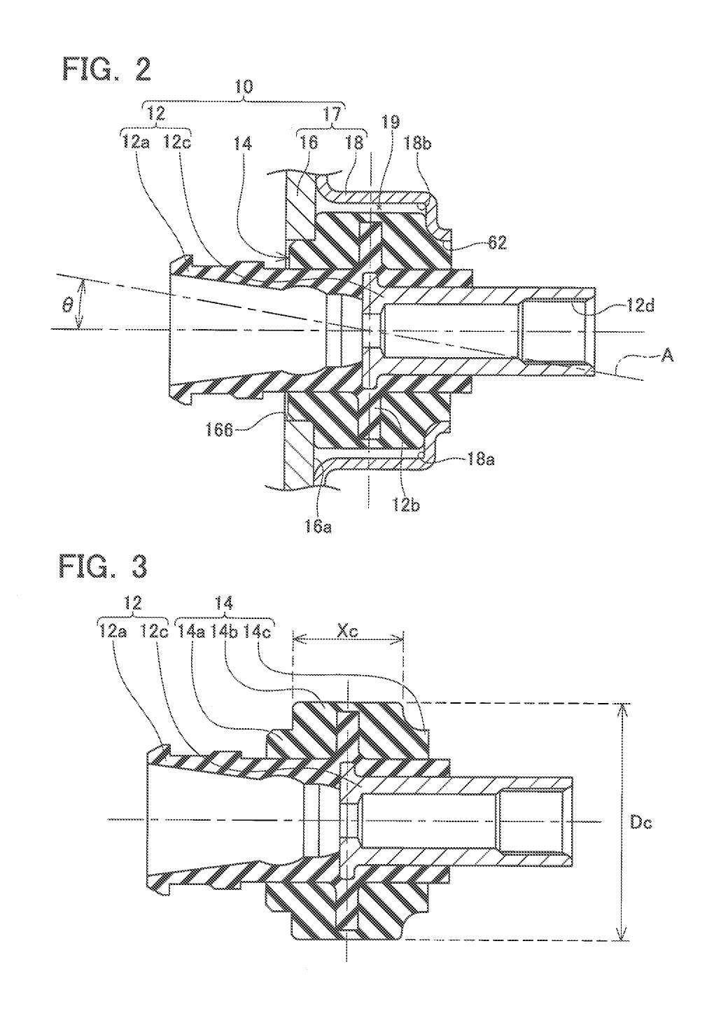

The configuration of the terminal supporting apparatus 10 of Embodiment 1 will be described with reference to FIGS. 2 to 4. The terminal supporting apparatus 10 is composed mainly of a hub 12, a cushion 14 (an example of a cushion member), and a housing 17.

The housing 17 has a mounting plate 16 and a bracket 18. The mounting plate 16 is formed of a metal such as iron. An open hole 16b is formed through the mounting plate 16. One ends of the hub 12 and the cushion 14 are attached to the open hole 16b. The mounting plate 16 is fixed to the cable fixing member 26 in the engine room.

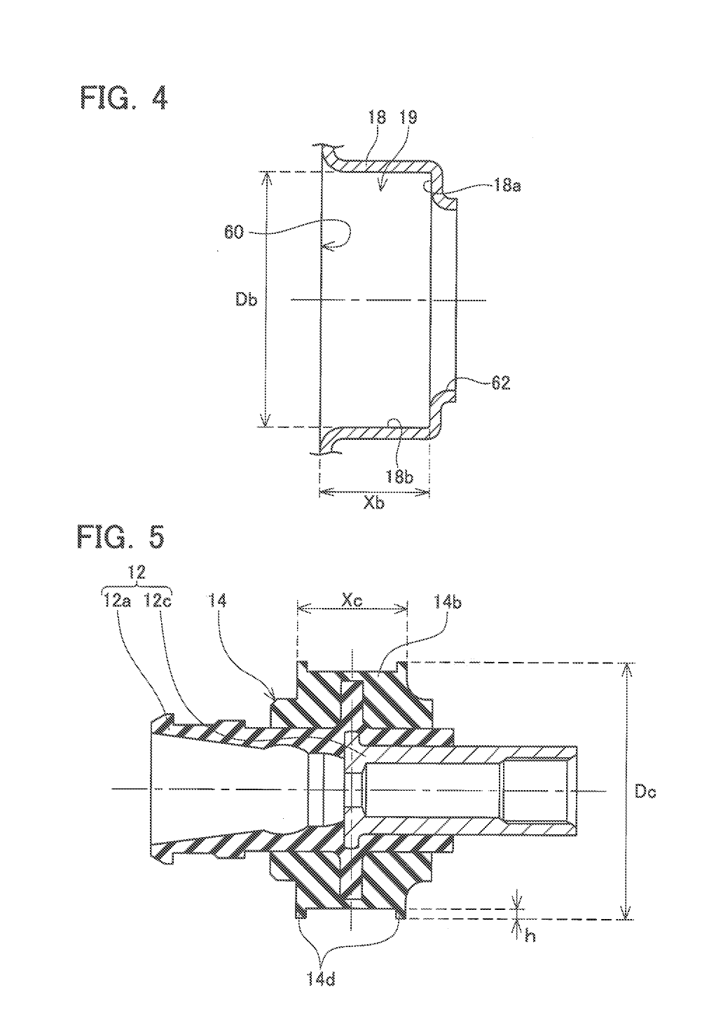

The bracket 18 is formed of a metal such as iron, and is fixed to the mounting plate 16. As shown in FIG. 4, one end 60 of the bracket 18 is open, and an open hole 62 is formed at the other end thereof. The other ends of the hub 12 and the cushion 14 are attached to the open hole 62. When the bracket 18 is fixed to the mounting plate 16, the one end 60 of the bracket 18 is closed by the mounting plate 16, and a housing part 19 is formed in the housing 17. The housing part 19 has a dimension Xb in a direction along which its axis extends (axial direction), and a dimension Db in a direction perpendicular to the axis (radial direction).

As shown in FIGS. 2 and 3, the hub 12 is composed of a guide part 12a and a main body 12c. The guide part 12a is fixed to one end of the main body 12c so as to be substantially coaxial with the main body 12c. The guide part 12a and the main body 12c are integrally molded by insert molding. The guide part 12a and the main body 12c are tubular in shape, and a through-hole 12d is formed penetrating through the guide part 12a and the main body 12c to provide communication therebetween. As shown in FIG. 1, when the AT cable 30 is connected to the hub 12, the inner cable 29 is inserted into the through-hole 12d. The outer cable 34 is inserted into the through-hole 12d from the main body 12c side (right side in FIG. 1) and fixed to the main body 12c. The guide part 12a has a flange 12b. The flange 12b is formed on an outer periphery of the guide part 12a so as to have a ring shape around the outer periphery of the guide part 12a.

The cushion 14 is provided on the outer periphery of the hub 12 (guide part 12a) so as to surround the flange 12b. The cushion 14 may be formed of, for example, a rubber material such as EPDM (ethylene propylene diene monomer rubber), NR (natural rubber), CR (chloroprene rubber), or the like. The cushion 14 has a first small-diameter part 14a fitted in the open hole 16b of the mounting plate 16, a large-diameter part 14b housed in the housing part 19 of the housing 17, and a second small-diameter part 14c fitted in the open hole 62 of the bracket 18. The first small-diameter part 14a, the large-diameter part 14b, and the second small-diameter part 14c are integrally molded.

The first small-diameter part 14a is disposed on the guide part 12a side of the hub 12. An outer peripheral surface of the first small-diameter part 14a is in firm contact with an inner wall surface of the open hole 16b. The second small-diameter part 14c is disposed on the main body 12c side of the hub 12. An outer peripheral surface of the second small-diameter part 14c is in firm contact with an inner wall surface of the open hole 62. The large-diameter part 14b is disposed surrounding an outer surface (front and rear surfaces, outer peripheral surface) of the flange 12b. When the cushion 14 is housed in the housing part 19 so that the axis of the housing part 19 and the axis of the hub 12 coincide with each other (i.e., twisting angle=0°), no clearance is formed between the large-diameter part 14b and the inner wall surface of the housing 17 (housing part 19) in the direction (axial direction) along which the axis (cable axis) of the housing part 19 extends, while a clearance is formed therebetween in the direction (radial direction) perpendicular to the axis (cable axis) of the housing part 19.

That is, in the state where the cushion 14 is not housed in the housing part 19 of the housing 17, an axial dimension Xc (refer to FIG. 3) of the large-diameter part 14b is equal to or larger than an axial dimension Xb (refer to FIG. 4) of the housing part 19 (Xc≧Xb). On the other hand, a radial dimension Dc (refer to FIG. 3) of the large-diameter part 14b is smaller than a radial dimension Db (refer to FIG. 4) of the housing part 19 (Db>Dc). Thereby, as shown in FIG. 2, a clearance C is formed between the large-diameter part 14b and an inner wall surface 18b, and no clearance is formed between the large-diameter part 14b and each of inner wall surfaces 16a and 18a. The axial dimension Xc of the large-diameter part 14b may be in a range of 9.5 mm≦Xc≦13.5 mm, and the clearance C may be in a range of 0.1 mm≦C≦0.8 mm. Whether or not a clearance is formed between the cushion 14 and each of the inner wall surfaces 16a, 18a, and 18b of the housing part 19 depends on the load acting on the cushion 14, and/or the housing state of the cushion 14 in the housing part 19 (e.g., twisting angle or the like). Therefore, as long as a diagonal static spring constant described later satisfies a predetermined condition, it doesn't matter whether a clearance is actually formed between the inner wall surface of the housing part 19 and the cushion 14. That is, the dimension of the cushion 14 in the state where the cushion 14 is not housed in the housing part 19 may be a dimension that allows the above-mentioned clearance to be formed between the cushion 14 and the housing part.

The cushion 14 and the hub 12 can be integrally molded by insert molding. When the cushion 14 and the hub 12 are integrally molded, no clearance is formed between the cushion 14 and the hub 12. The integral molding of the hub 12 and the cushion 14 facilitates assembly of the terminal supporting apparatus 10.

Further, in Embodiment 1, protrusions, grooves, and the like are not formed on the surface of the cushion 14. The cushion 14 has a flat surface. Since protrusions, grooves, and the like are not formed on the surface of the cushion 14, deformation of the cushion 14 is restrained, and so-called stroke loss is restrained. As shown in FIG. 5, the cushion 14 may have projections 14d formed at both ends of the large-diameter part 14b in the axial direction. The projections 14d are formed so as to project in the radial direction from the outer peripheral surface of the large-diameter part 14b. Since the projections 14d are formed only on a part of the large-diameter part 14b, the projections 14d may have a height h that allows the projections 14d to come in contact with the inner wall surface 18b of the housing part 19. Further, the outer shape of the large-diameter part 14b of the cushion 14 is not limited to the cylindrical shape but may be a barrel shape or a drum shape.

As described above, in the terminal supporting apparatus 10 of Embodiment 1, the dimensions (Xb and Db) of the housing part 19 and the dimensions (Xc and Dc) of the cushion 14 (specifically, the large-diameter part 14b) are appropriately set. Therefore, when the cushion 14 is housed in the housing part 19 so that an angle (twisting angle) formed between the axis of the housing part 19 and the axis of the hub 12 is in a range of 0.0° to 6.0° as described later, the diagonal static spring constant of the cushion 14 in the axial direction is in a range of 350 to 600 N/mm, regardless of the twisting angle. That is, in the terminal supporting apparatus 10, when the cushion 14 is housed in the housing part 19 of the housing 17, the hub 12 and the cushion 14 are attached to the housing 17. Further, the cushion 14 is formed of an elastically deformable material, and a clearance is formed between the cushion 14 and the inner wall surface of the housing part 19. Therefore, the hub 12 and the cushion 14 might be tilted when attached to the housing 17 (i.e., the axis of the hub 12 might be tilted as shown by line A in FIG. 2). In the terminal supporting apparatus 10 of Embodiment 1, when the twisting angle in the state where the hub 12 and the cushion 14 are attached to the housing 17 is in the range of 0.0° to 6.0°, the diagonal static spring constant of the cushion 14 in the axial direction is adjusted in the range of 350 to 600 N/mm, regardless of the twisting angle. Thereby, the terminal supporting apparatus 10 of Embodiment 1 can significantly improve the vibration control performance, as seen from experimental results described later. The reason why the diagonal static spring constant is adopted as the static spring constant of the cushion 14 is because the cushion 14 has hysteresis characteristics in which displacement at compression and displacement at tension are different from each other.

Hereinafter, a description will be given of an experiment in which terminal supporting apparatuses according to Embodiment 1 were actually produced and the vibration control effects thereof were measured. In the experiment, terminal supporting apparatuses having cushions of different dimensions were actually produced, and the diagonal static spring constants of the cushions in the axial direction and the vibration control effects thereof were measured. Specifically, terminal supporting apparatuses having three types of cushions shown in Table 1 were produced. In experimental examples 1 and 2, the axial length Xb of the housing part 19 was 13.5 mm, and the radial length Db of the housing part 19 was 24.0 mm. The cushion of experimental example 1 had the shape shown in FIG. 2, and the cushion of experimental example 2 had the shape shown in FIG. 5. On the other hand, in comparative example 1, the axial length Xb of the housing part 19 was 9.5 mm, and the radial length Db of the housing part 19 was 24.0 mm. The configurations other than mentioned above are identical among experimental examples 1 and 2 and comparative example 1.

TABLE 1

| | | | | | Dynamic- |
|---|---|---|---|---|---|
| | | | | Pro- | to-Static |
| | Axial | Radial | Radial | jection | Modulus |
| | Length | Length | Clear- | Height | Ratio of |
| | Xc | Dc | ance | h | Rubber |
| Experi- | 13.5 mm | 22.825 mm | 0.5875 mm | 0.0 mm | 1.4 |
| mental | | | | | |
| Example 1 | | | | | |
| Experi- | 13.5 mm | 22.825 mm | 0.5875 mm | 1.0 mm | 1.4 |
| mental | | | | | |
| Example 2 | | | | | |
| Compar- | 9.5 mm | 22.825 mm | 0.0875 mm | 0.0 mm | 1.7 |
| ative | | | | | |
| Example 1 | | | | | |

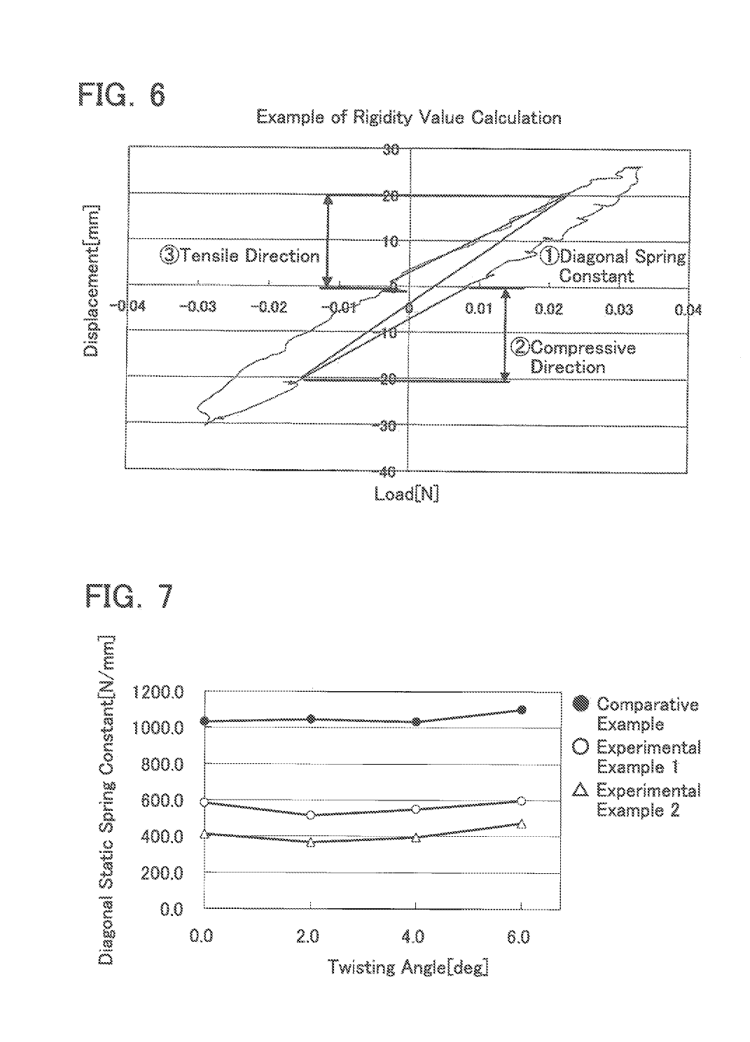

Next, the diagonal static spring constants of the cushions of the respective produced terminal supporting apparatuses were measured. First, the hub 12 and the cushion 14 were housed in the housing 17, and an attachment angle of the hub 12 to the housing 17 was adjusted. Specifically, the attachment angle was adjusted so that the twisting angle was 0.0°, 2.0°, 4.0°, and 6.0°. Next, the diagonal static spring constants were measured for the respective twisting angles of 0.0°, 2.0°, 4.0°, and 6.0°. That is, as shown in FIG. 6, a force in a tensile direction and a force in a compressive direction were repeatedly alternately applied to the hub 12 in the axial direction, and displacement (flexure) of the hub 12 at each time was measured. Then, displacement at which the load on the hub 12 became +20N when the force in the tensile direction was applied to the hub 12 was specified, and displacement at which the load on the hub 12 became −20N when the force in the compressive direction was applied to the hub 12 was specified. Then, a tilt was calculated based on the displacement at which the load on the hub 12 became +20N and the displacement at which the load on the hub 12 became −20N, thereby obtaining the diagonal static spring constant. The displacements used for the calculation of the diagonal static spring constant were the values measured when the tensile force or the compressive force in the second cycle was applied. That is, when application of the tensile force and the compressive force to the hub 12 is regarded as one cycle, the diagonal static spring constant was calculated based on the displacement caused by the tensile force in the second cycle and the displacement caused by the compressive force in the second cycle. FIG. 7 shows the measured diagonal static spring constants. As is apparent from FIG. 7, in experimental examples 1 and 2, the diagonal static spring constants were in the range of 350 to 600 N/mm for all the twisting angles from 0.0° to 6.0°. On the other hand, in comparative example 1, the diagonal static spring constants exceeded 1000 N/mm for all the twisting angles from 0.0° to 6.0°.

Next, the vibration control characteristics of the respective produced terminal supporting apparatuses were measured. The measurement of the vibration control characteristics was performed as follows. One end of the hub 12 was vibrated by a vibrator, vibration transmitted to the other end of the hub 12 was measured in the housing 17 (bracket 18), and the measured vibration level was subtracted from the input vibration level, thereby calculating vibration control effect dB. The frequency of the vibration input from the vibrator to the hub 12 was in accordance with the frequency of the vibration input from the engine. In this embodiment, the frequency was 800 to 3000 Hz. The measurement of the vibration control characteristics was performed with the twisting angle being varied from 0° to 6°. The measurement results are shown in Table 2. In Table 2, the diagonal static spring constants are also shown. The larger the negative value of the vibration control effect is, the more the vibration transmitted from the hub to the housing is reduced, which indicates that high vibration control effect is achieved.

TABLE 2

| | Experi- | Experi- | |
|---|---|---|---|
| | mental | mental | Comparative |
| | Example 1 | Example 2 | Example 1 |
| Diagonal Static Spring Constant | 582.3 | 411.3 | 1031.0 |
| (Twisting Angle 0°) | | | |
| Diagonal Static Spring Constant | 514.0 | 366.0 | 1044.3 |
| (Twisting Angle 2.0°) | | | |
| Diagonal Static Spring Constant | 547.0 | 394.3 | 1030.3 |
| (Twisting Angle 4.0°) | | | |
| Diagonal Static Spring Constant | 597.0 | 474.3 | 1099.0 |
| (Twisting Angle 6.0°) | | | |
| Vibration Control Effect | −27.88 dB | −25.78 dB | −11.22 dB |
| (Twisting Angle 0°) | | | |
| Vibration Control Effect | −29.42 dB | −24.75 dB | −12.33 dB |
| (Twisting Angle 2.0°) | | | |
| Vibration Control Effect | −26.32 dB | −20.75 dB | −7.76 dB |
| (Twisting Angle 4.0°) | | | |
| Vibration Control Effect | −23.10 dB | −20.62 dB | −6.72 dB |
| (Twisting Angle 6.0°) | | | |

As is apparent from Table 2, the terminal supporting apparatuses of experimental examples 1 and 2 can provide satisfactory vibration control effects at all the twisting angles, as compared to the terminal supporting apparatus of comparative example 1.

### Embodiment 2

Hereinafter, a terminal supporting apparatus according to Embodiment 2 will be described. The terminal supporting apparatus according to Embodiment 2 supports an end of an AT cable, as in Embodiment 1. In Embodiment 2, however, the terminal supporting apparatus (the terminal supporting apparatus 11 in FIG. 1) on the input side of the AT cable has the configuration according to the present invention, while the terminal supporting apparatus (the terminal supporting apparatus 10 in FIG. 1) on the output side of the AT cable has the conventionally known configuration. Therefore, the terminal supporting apparatus on the input side of the AT cable will be mainly described hereinafter. The components other than the terminal supporting apparatus (e.g., the AT cable and the like) are identical to those of Embodiment 1, and therefore, are denoted by the same reference characters as in Embodiment 1, and the description thereof is omitted.

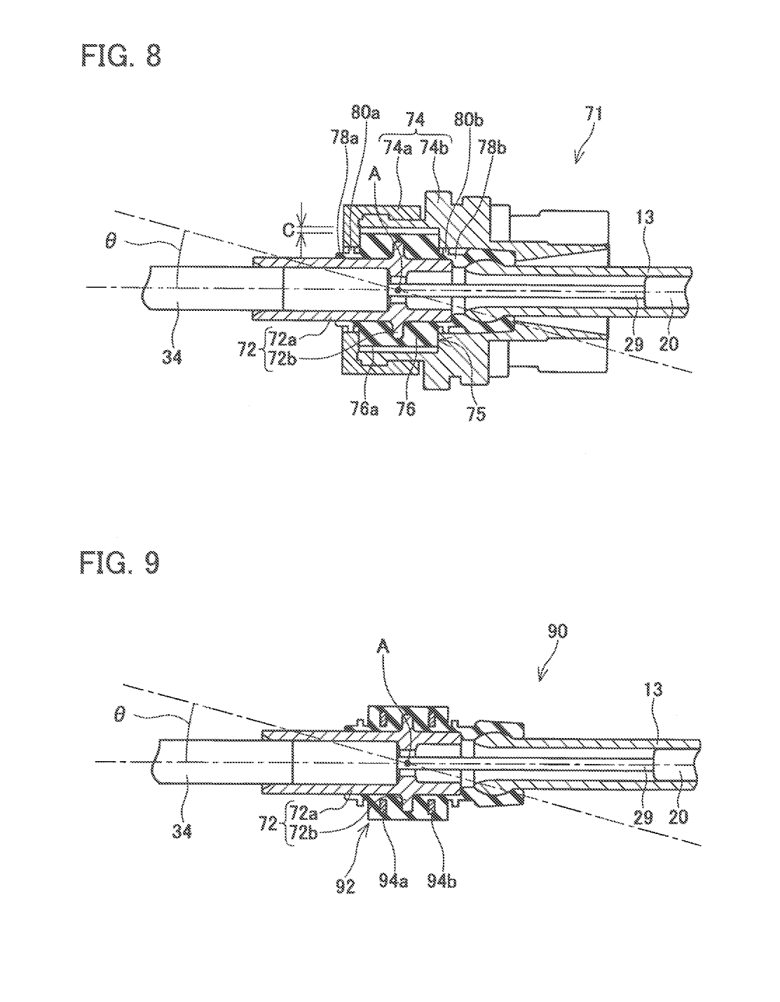

The configuration of a terminal supporting apparatus 71 according to Embodiment 2 will be described with reference to FIG. 8. As shown in FIG. 8, the terminal supporting apparatus 71 is composed of a hub 72, a guide pipe 13, a cushion 75 (an example of a cushion member), and a housing 74.

The housing 74 has a cover 74b and a cap 74a. The cover 74b is formed of resin. A part of the hub 72, the cushion 75, and a part of the guide pipe 13 are housed inside the cover 74b. A part of the hub 72 protrudes from one end (left end in FIG. 8) of the cover 74b, a part of the guide pipe 13 protrudes from the other end (right end in FIG. 8) of the cover 74b, and the cushion 75 is located inside the cover 74b. The cover 74b is fixed to a housing of a shift lever device.

The cap 74a is formed of resin, and is attached to the one end (left end in FIG. 8) of the cover 74b. As a mechanism for attaching the cap 74a to the cover 74b, a screw mechanism may be used, for example. That is, an internal screw thread is formed on an inner peripheral surface of the cap 74a, and an external screw thread is formed on an outer peripheral surface of the cover 74b. The internal and external screw threads are engaged with each other to attach the cap 74a to the cover 74b. When the cap 74a is attached to the cover 74b, the one end of the cover 74b is closed by the cap 74a, and the cushion 75 is housed in a space surrounded by the cap 74a and the cover 74b.

The hub 72 is formed in a tubular shape, and has a cylindrical part 72a and a flange part 72b. An outer cable 34 is fixed to one end of the cylindrical part 72a (left side relative to the flange part 72b in FIG. 8). The other end of the cylindrical part 72a (right side relative to the flange part 72b in FIG. 8) is connected to the guide pipe 13 via the cushion 75, and an inner cable 29 is inserted in the cylindrical part 72a. The flange part 72b is formed on an outer periphery of the cylindrical part 72a so as to have a ring shape around the outer periphery of the cylindrical part 72a.

The guide pipe 13 is formed in a tubular shape, and the inner cable 29 and an input rod 20 are inserted in the guide pipe 13. The input rod 20 is guided by the guide pipe 13. A base end (left end in FIG. 8) of the guide pipe 13 is swingably attached to the cover 74b via the cushion 75. Therefore, the input rod 20 is swingable with respect to the cover 74b in accordance with operation of the shift lever.

The cushion 75 is disposed on an outer periphery of the hub 72 so as to surround the flange part 72b. The cushion 75 may be formed of, for example, a rubber material such as EPDM (ethylene propylene diene monomer rubber), NR (natural rubber), CR (chloroprene rubber), or the like. Preferably, the dynamic-to-static modulus ratio of the cushion 75 is not higher than 1.7. The dynamic-to-static modulus ratio of the cushion 75 not higher than 1.7 enhances the vibration control effect. The dynamic-to-static modulus ratio is represented by the ratio of the dynamic spring constant to the static spring constant.

The cushion 75 has a large-diameter part 76 in contact with front and back surfaces of the flange part 72b, a first small-diameter part 78a provided on one end side (left side in FIG. 8) of the large-diameter part 76, and a second small-diameter part 78b provided on the other end side (right side in FIG. 8) of the large-diameter part 76. The diameters of the first small-diameter part 78a and the second small-diameter part 78b are smaller than the diameter of the large-diameter part 76. The large-diameter part 76, the first small-diameter part 78a, and the second small-diameter part 78b are integrally molded.

A clearance is formed between an outer peripheral surface 76a of the large-diameter part 76 and an inner peripheral surface of the cover 74b. That is, in the state where the cushion 75 is not housed in the housing 74, a radial dimension Dc of the large-diameter part 76 is smaller than a radial dimension Db of the inner space of the housing 74 (Db>Dc). The clearance between the outer peripheral surface 76a of the large-diameter part 76 and the inner peripheral surface of the cover 74b is in a range of 0.1 mm≦C≦0.8 mm, as in Embodiment 1. The clearance not smaller than 0.1 mm ensures high vibration control effect. In addition, the clearance not larger than 0.8 mm prevents the rigidity of the cushion 75 in the axial direction from being excessively low.

On the other hand, no clearance is formed between the end surface of the large-diameter part 76 and the inner surface of the housing 74. That is, in the state where the cushion 75 is not housed in the housing 74, an axial dimension Xc of the large-diameter part 76 is equal to or larger than an axial dimension Xb of the internal space of the housing 74 (Xc≧Xb). Accordingly, the end surface of the large-diameter part 76 (the end surface in the axial direction of the cable) is in contact with the inner surface of the housing 74. The axial dimension Xc of the large-diameter part 76 is in the range of 9.5 mm≦Xc≦13.5 mm, as in Embodiment 1. The axial dimension Xc of the large-diameter part 76 not smaller than 9.5 mm enhances the vibration control effect. In addition, the axial dimension Xc of the large-diameter part 76 not larger than 13.5 mm reduces the stroke loss to a satisfactory level.

An inner peripheral surface of the first small-diameter part 78a is in contact with the hub 72 at one end side (left side in FIG. 8) of the large-diameter part 76. A clearance is formed between the first small-diameter part 78a and the cap 74a. A tip end of the first small-diameter part 78a is located outside the housing 74. A protruding portion 80a that protrudes in the radial direction is formed on the outer peripheral surface of the first small-diameter part 78a. The protruding portion 80a is formed in a ring shape around the outer periphery of the cushion 75.

The second small-diameter part 78b extends in the cover 74b from the large-diameter part 76 toward the guide pipe 13, and is connected to the base end of the guide pipe 13. One end side of the inner peripheral surface of the second small-diameter part 78b is in contact with the hub 72, and the other end side thereof is in contact with the guide pipe 13. The outer peripheral surface of the second small-diameter part 78b is in contact with the inner surface of the cover 74b in a region connected to the guide pipe 13. In the other region (including a range in contact with the hub), a clearance is formed between the outer peripheral surface of the second small-diameter part 78b and the inner surface of the cover 74b. A tip end of the second small-diameter part 78b is located inside the housing 74 (cover 74b). A protruding portion 80b that protrudes in the radial direction is formed on the outer peripheral surface of the second small-diameter part 78b. The protruding portion 80b is formed in a ring shape around the outer periphery of the cushion 75.

The protruding portions 80a and 80b are located in symmetrical positions with respect to the flange part 72b of the hub 72. As is apparent from FIG. 8, the hub 72 and the outer cable 34 tilt (are twisted, in other words) with respect to the housing 74 around point A in FIG. 8. The protruding portions 80a and 80b symmetrical with respect to the point A are formed on the small-diameter parts 78a and 78b of the cushion 75, respectively. Therefore, even if the hub 72 and the outer cable 34 tilt, the protruding portions 80a and 80b come in contact with the inner surface of the housing 34 to prevent further tilting of the hub 72 and the outer cable 74.

As described above, in the terminal supporting apparatus 71 of Embodiment 2, a clearance is formed between the outer peripheral surface of the cushion 75 (specifically, the outer peripheral surface of the large-diameter part 76) and the housing 74. This clearance is in the range of 0.1 mm≦C≦0.8 mm. Further, the axial dimension of the large-diameter part 76 of the cushion 75 is in the range of 9.5 mm≦Xc≦13.5 mm. Therefore, high vibration control effect can be achieved.

Hereinafter, a description will be given of an experiment in which terminal supporting apparatuses 71 according to Embodiment 2 were actually produced and the vibration control effects thereof were measured. In the experiment, terminal supporting apparatuses having cushions of different dimensions were actually produced, and the diagonal static spring constants of the cushions in the axial direction and the vibration control effects thereof were measured. Specifically, terminal supporting apparatuses having nine types of cushions shown in Table 3 were produced. As for the dimensions of the inner space of the housing 74 (the space where the large-diameter part of the cushion is housed (corresponding to the housing part 19 of Embodiment 1)), the axial length thereof is “the axial dimension of the cushion−0.55 mm”, and the radial dimension thereof is 24.0 mm.

TABLE 3

| | | | | Dynamic-to- |
|---|---|---|---|---|
| | Axial | Radial | Radial | Static Modulus |
| | Length Xc | Length Dc | Clearance | Ratio of Rubber |
| Experimental | 9.5 mm | 22.825 mm | 0.5875 mm | 1.4 |
| Example 3 | | | | |
| Experimental | 11.5 mm | 22.825 mm | 0.5875 mm | 1.4 |
| Example 4 | | | | |
| Experimental | 13.5 mm | 22.825 mm | 0.5875 mm | 1.4 |
| Example 5 | | | | |
| Experimental | 9.5 mm | 23.425 mm | 0.2875 mm | 1.7 |
| Example 6 | | | | |
| Experimental | 9.5 mm | 23.125 mm | 0.4375 mm | 1.7 |
| Example 7 | | | | |
| Experimental | 9.5 mm | 22.825 mm | 0.5875 mm | 1.7 |
| Example 8 | | | | |
| Experimental | 9.5 mm | 22.425 mm | 0.7875 mm | 1.7 |
| Example 9 | | | | |
| Comparative | 9.5 mm | 23.825 mm | 0.0875 mm | 1.4 |
| Example 2 | | | | |
| Comparative | 11.5 mm | 23.825 mm | 0.0875 mm | 1.4 |
| Example 3 | | | | |

Next, the diagonal static spring constants of the cushions of the respective produced terminal supporting apparatuses were measured. The measurement was performed under the condition that the twisting angle was 0.0°. The procedure to measure the diagonal spring constants was identical to that in the experiment of Embodiment 1. The measurement results are shown in Table 4. As shown in Table 4, in experimental examples 3 to 9, the diagonal static spring constants are in a range of 400 to 600 N/mm. On the other hand, in comparative examples 2 and 3, the diagonal static spring constants exceed 600 N/mm.

Next, the vibration control characteristics of the respective produced terminal supporting apparatuses were measured. The measurement of the vibration control characteristics was identical to that in the experiment of Embodiment 1, and was performed under the condition that the twisting angle was 0.0°. The measurement results are shown in Table 4. As is apparent from Table 4, in the terminal supporting apparatuses of experimental examples 3 to 9, great vibration control effects not smaller than −16.5 dB are achieved. On the other hand, in the terminal supporting apparatuses of comparative examples 2 and 3, the vibration control effects are not so great as compared to the terminal supporting apparatuses of experimental examples 3 to 9.

TABLE 4

| | Diagonal Static Spring | Vibration Control |
|---|---|---|
| | Constant | Effect |
| Experimental Example 3 | 421.0 | −25.27 dB |
| Experimental Example 4 | 418.9 | −25.97 dB |
| Experimental Example 5 | 391.8 | −27.88 dB |
| Experimental Example 6 | 524.8 | −16.71 dB |
| Experimental Example 7 | 501.1 | −17.79 dB |
| Experimental Example 8 | 474.4 | −21.20 dB |
| Experimental Example 9 | 438.8 | −21.15 dB |
| Comparative Example 2 | 1051.1 | −11.37 dB |
| Comparative Example 3 | 656.6 | −12.58 dB |

While specific embodiments of the terminal supporting apparatuses disclosed in the present specification have been described in detail, these embodiments are for illustrative purposes only and are not intended to limit the scope of the following claims. The techniques described in the claims encompass various modifications and changes made to the specific embodiments illustrated above.

For example, in the terminal supporting apparatus of Embodiment 2, a cable assembly 90 shown in FIG. 9 may be adopted. In the cable assembly 90, the hub 72, the guide pipe 13, and a cushion 92 are integrated with each other. The cable assembly 90 is housed in the housing 74 of Embodiment 2. In the cable assembly 90, ring-shaped metal plates 94a and 94b are disposed in the cushion 92. The metal plates 94a and 94b are disposed symmetrically with respect to the flange part 72b of the hub 72. The metal plates 94a and 94b disposed in the cushion 92 cause the cushion 92 to be divided in the axial direction, and thereby the rigidity of the cushion 92 in the axial direction can be switched between two levels. That is, the cushion 92 has a low spring constant in a low load region, and has a high spring constant in a high load region. Thereby, the stroke loss can be reduced with the vibration control effect being enhanced.

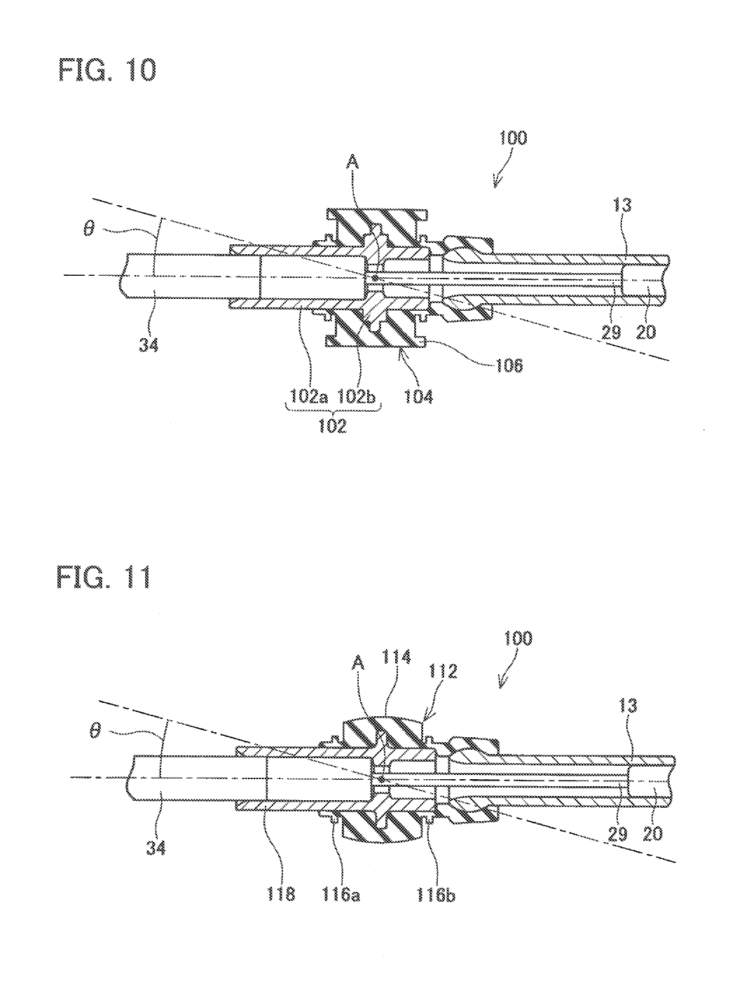

Further, the terminal supporting apparatus of Embodiment 2 may adopt a cable assembly 100 shown in FIG. 10. In the cable assembly 100, a flange part 102b of a hub 102 is formed in a stepped shape, and a protrusion 106 that protrudes in the axial direction is formed on an end surface of a large-diameter part of a cushion 104. The protrusion 106 is formed along an outer circumference of the end surface of the large-diameter part of the cushion 104. In the example shown in FIG. 10, since the flange part 102b of the hub 102 has the stepped shape, the axial dimension of the cushion 104 also changes in two steps in the radial direction. That is, the axial dimension of the cushion 104 is reduced at the inner circumference side of the cushion 104, and the axial dimension of the cushion 104 is increased at the outer circumference side of the cushion 104. Therefore, also in the example shown in FIG. 10, the rigidity of the cushion 104 in the axial direction can be switched between two levels, and thereby the stroke loss can be reduced with the vibration control effect being enhanced. In the cable assembly 100 shown in FIG. 10, since the protrusion 106 is formed on the cushion 104, influence resulting from a control cable being twisted can be reduced.

Further, the terminal supporting apparatus of Embodiment 2 may adopt a cable assembly 110 shown in FIG. 11. As shown in FIG. 11, in the cable assembly 110, an outer peripheral surface 114 of a large-diameter part of a cushion 112 is tapered. Therefore, the diameter of the large-diameter part of the cushion 112 is reduced at its axial end surface. Further, on an outer peripheral surface of a small-diameter part of the cushion 112, protruding portions 116a and 116b are formed symmetrically with respect to swing center A of a hub 118. These components, when the control cable is twisted, prevent the twisting angle from increasing. Further, since the outer peripheral surface 114 of the large-diameter part of the cushion 112 is tapered, even if the control cable is twisted, contact between the outer peripheral surface 114 and the inner surface of the housing 74 is avoided, and the rigidity of the cushion 112 in the axial direction is prevented from increasing.

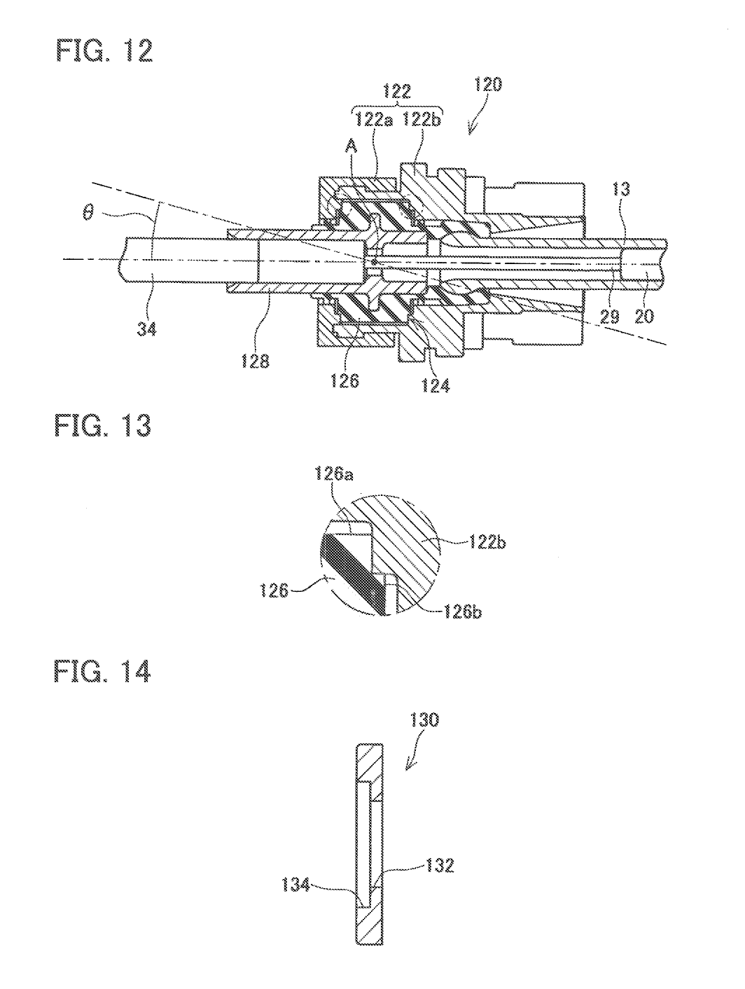

Further, as shown in FIG. 12, in a terminal supporting apparatus 120, clearances may be partially formed on both end surfaces of a large-diameter part 126 of a cushion 124. That is, the large-diameter part 126 is in contact with a housing 122 at outer circumference parts of the both end surfaces thereof, while clearances are formed between the large-diameter part 126 and the housing 122 at inner circumference parts of the both end surfaces thereof. More specifically, as shown in FIG. 13, a part (outer circumference part) of the inner surface (the surface facing the end surface 126b of the large-diameter part 126) of a cover 122b protrudes to the cushion 124 side, and is in contact with the cushion 124. A clearance is formed between an outer peripheral surface 126a of the large-diameter part 126 and the inner surface of the cover 122b. A cap 122a side is configured in like manner as the cover 122b side. In this configuration, when a low load acts on the cushion 124, the end surface of the large-diameter part 126 of the cushion 124 is not in perfect contact with the inner surface of the housing 122, and a clearance is partially formed. Accordingly, the rigidity of the cushion 124 in the axis direction can be reduced. On the other hand, when a high load acts on the cushion 124, the entirety of the end surface 126b of the large-diameter part 126 of the cushion 124 is in contact with the inner surface of the housing 122, and the rigidity of the cushion 124 in the axial direction is increased. Accordingly, the rigidity of the cushion 124 in the axial direction can be switched between two levels, and the stroke loss can be reduced with the vibration control effect being enhanced. In order to cause a part of the inner surface (the surface facing the large-diameter part 126) of the housing 122 to protrude, a component 130 as shown in FIG. 14 may be housed in the housing 122. The component 130 is a washer-shape component, and has through-holes 132 and 134 through which the hub 128 penetrates. When two components 130 are disposed opposed to each other at the both ends in the housing 122, the terminal supporting apparatus 120 shown in FIG. 12 can be easily configured.

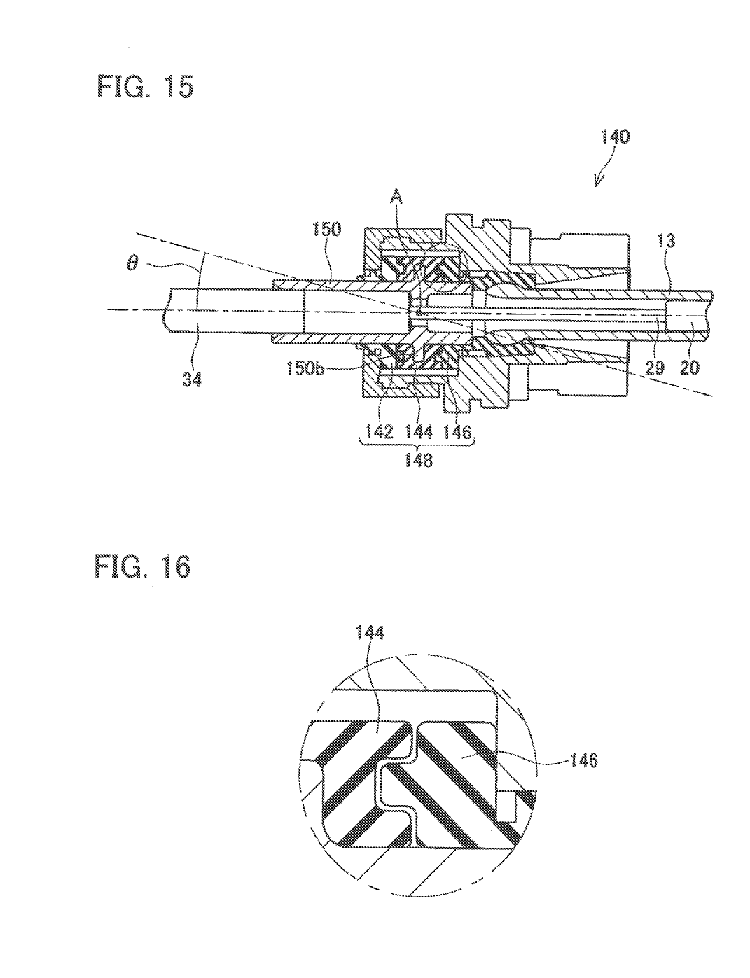

Furthermore, a cushion 148 may be divided into three parts 142, 144, and 146 as in a terminal supporting apparatus 140 shown in FIGS. 15 and 16. The cushion 144 disposed in the center is in contact with a flange part 150b of a hub 150, and ring-shaped recessed portions are formed on both side surfaces of the cushion 144. The cushions 142 and 146 are disposed on both sides of the cushion 144, and ring-shaped protruding portions that protrude toward the cushion 144 are formed on the cushions 142 and 146. The protruding portions of the cushions 142 and 146 are fitted in the recessed portions of the cushion 144. The hardness of the cushion 144 is higher than the hardness of the cushions 142 and 146. For example, the rubber hardness of the cushion 144 can be 60°, and the rubber hardness of the cushions 142 and 146 can be 40°. Thus, by dividing the cushion 148 into three parts and varying the hardness among the cushions 142, 144, and 146, the rigidity of the cushion 148 in the axial direction can be switched between two levels (low load and low spring constant+high load and high spring constant). Thereby, the stroke loss can be reduced with the vibration control effect being enhanced.

The technical elements described in this specification or in the drawings exhibit technical utility singly or in various combinations and are not limited to the combinations recited in the claims as filed. Moreover, the techniques illustrated in this specification or in the drawings simultaneously attain a plurality of purposes, and attaining one of the purposes per se offers technical utility.

1. A terminal supporting apparatus for supporting at least one of two ends of a control cable having an inner cable and an outer cable in which the inner cable is inserted, the terminal supporting apparatus comprising:
a hub attached to an end of the outer cable, the hub having a flange on an outer periphery thereof;
a cushion member disposed so as to surround the outer periphery of the hub, the cushion member being in contact with the flange at both a front surface and a rear surface of the flange; and
a housing having a housing part that houses the cushion member, wherein
when an angle formed between an axis of the housing part and an axis of the hub is varied in a range of 0.0° to 6.0°, a diagonal static spring constant of the cushion member in an axial direction thereof is in a range of 350 to 600 N/mm.

2. The terminal supporting apparatus according to claim 1, wherein
dimensions of the cushion member and the housing part are set such that no clearance is formed between the cushion member and an inner wall surface of the housing part in a direction along which the axis of the housing part extends, while a clearance is formed in a direction perpendicular to the axis of the housing part.

3. The terminal supporting apparatus according to claim 2, wherein
when a clearance in a direction perpendicular to the axes of the cushion member and the housing part is C, 0.1 mm≦C≦0.8 mm is satisfied.

4. The terminal supporting apparatus according to claim 3, wherein
when a length of the cushion member in the axial direction thereof is Xc, 9.5 mm≦Xc≦13.5 mm is satisfied.

5. A terminal supporting apparatus for supporting at least one of two ends of a control cable having an inner cable and an outer cable in which the inner cable is inserted, the terminal supporting apparatus comprising:
a hub attached to an end of the outer cable, the hub having a flange on an outer periphery thereof;
a cushion member disposed so as to surround the outer periphery of the hub, the cushion member being in contact with the flange at both a front surface and a rear surface of the flange; and
a housing having a housing part that houses the cushion member, wherein
when a clearance in a direction perpendicular to the axes of the cushion member and the housing part is C, 0.1 mm≦C≦0.8 mm is satisfied.

6. The terminal supporting apparatus according to claim 5, wherein
when a length of the cushion member in the axial direction thereof is Xc, 9.5 mm≦Xc≦13.5 mm is satisfied.

7. The terminal supporting apparatus according to claim 1, wherein
when a clearance in a direction perpendicular to the axes of the cushion member and the housing part is C, 0.1 mm≦C≦0.8 mm is satisfied.

8. The terminal supporting apparatus according to claim 7, wherein
when a length of the cushion member in the axial direction thereof is Xc, 9.5 mm≦Xc≦13.5 mm is satisfied.
